(19) United States
(12) Patent Application Publication
(10) Pub. No.: US 2007/0102220 A1
(43) Pub. Date: May 10, 2007

(54) Vehicle collision detecting device

(75) Inventor: Shinichi Kiribayashi, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/590,589

(22) Filed: Oct. 31, 2006

(30) Foreign Application Priority Data
Nov. 9, 2005 (JP) 2005-325095
Aug. 31, 2006 (JP) 2006-235903

(51) Int. Cl. B60K 28/10; B60Q 1/00

(52) U.S. Cl. 180/274; 280/735; 340/436; 307/10.1

(57) ABSTRACT

A vehicle collision detecting device includes a capacitor type sensor mounted on a portion of the vehicle, a resonant circuit connected to the sensor by a lead wire and a microcomputer for judging a collision with an object and a breakdown of the lead wire. The sensor has a pair of plate electrodes and a dielectric member disposed between the electrodes so that its capacitance changes if the sensor is crushed. The resonant circuit is constituted of an oscillator generating an ac signal of a fixed frequency, a coil and a diagnostic capacitor. The microcomputer judges which of collision and wire breakdown takes place based on the voltage appears on the lead wire when the oscillator generates the signal of a fixed frequency.

### CROSS REFERENCE TO RELATED APPLICATION

The present application is based on and claims priority from Japanese Patent Applications: 2005-325095, filed Nov. 9, 2005 and 2006-235903, filed Aug. 31, 2006, the contents of which are incorporated herein by reference.

### BACKGROUND OF THE INVENTION

1. Field of the Invention

The present invention relates to a collision detecting device for detecting a collision with an object or a pedestrian at a portion of a vehicle that deforms when the collision takes place.

2. Description of the Related Art

In order to protect a pedestrian, it has been proposed. that a collision detecting device is mounted on a bumper of a vehicle to actuate a pedestrian protecting device such as an air bag. JP-A-2000-177514 or U.S. Pat. No. 6,561,301 B1, a counterpart U.S. patent, proposes a capacitor type collision detecting device that has a capacitor fixed to a surface portion of the bumper. The capacitor has a pair of electrodes and an elastic dielectric member disposed between the electrodes. When a collision takes place at the surface portion, the elastic dielectric member is crushed, so that the capacitance of the capacitor changes. The change in capacitance is detected by a capacitance detecting circuit, which generates an output signal of a specific frequency as a signal of the collision.

If the connection between the capacitance detecting circuit and the collision detecting device breaks down in the disclosed collision detecting device, the frequency of the output signal fluctuates, so that it is difficult to know which of a collision and a wire breakdown takes place,

### SUMMARY OF THE INVENTION

Therefore, an object of the invention is to provide an improved capacitor type collision detecting device.

Another object of the invention is to provide a capacitor type collision detecting device of a simple structure that can detect both the collision and the breakdown without an erroneous detection.

According to a feature of the invention, a vehicle collision detecting device includes a capacitor type sensor mounted on a portion of the vehicle, a driving circuit including an oscillator generating an ac signal of a fixed frequency and a resonant circuit constituted of a coil and a diagnostic capacitor and a microcomputer for judging a collision with an object and a breakdown of a lead wire based on the voltage appears on the lead wire. The resonant circuit is connected with the capacitor type sensor so as to compose a portion of the capacitance of the resonant circuit and with the oscillator so as to drive the resonant circuit at the fixed frequency.

In the above collision detecting device, the following features can be added: the diagnostic capacitor is connected either in parallel with or in series with the sensor; the judging means judges a collision if the voltage on the lead wire at the fixed frequency is lower than a first threshold voltage; the judging means judges a wire breakdown if the voltage on the lead wire at the fixed frequency is higher than a second threshold voltage; and the judging means includes a peak voltage holding circuit that holds a peak value of the voltage of the lead wire so as to either judge a collision if the peak value of voltage of the lead wire at the fixed frequency is lower than a first threshold voltage or to judge a wire breakdown if the peak value of voltage of the lead wire at the fixed frequency is higher than a second threshold voltage.

According to another feature of the invention, a vehicle collision detecting device includes a capacitor type sensor mounted on a portion of the vehicle, a resonant circuit connected to one of the plate electrodes of the sensor by a lead wire and constituted of an oscillator generating an ac signal of a fixed frequency, a coil and a diagnostic capacitor and means for judging a collision with an object and a breakdown of the lead wire according to a change in resonant frequency of that resonant circuit.

This collision detecting device may further include an oscillator oscillating the resonant circuit at a fixed frequency, and the judging means judges a collision and a wire breakdown by comparison of the voltage of the lead wire. The judging means may judge a collision with an object if the voltage of the lead wire is lower than a first reference voltage and judges a wire breakdown if the voltage of the lead wire is higher than a second reference voltage.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a schematic diagram illustrating a collision detecting device according to the first embodiment of the invention;

FIG. 2 is a schematic diagram illustrating a collision sensor of the collision detecting device shown in FIG. 1 mounted in a bumper of a vehicle;

FIG. 3 is a circuit diagram of the collision detecting device according to the first embodiment of the invention;

FIG. 4 is a graph showing a change in the impedance of a resonant circuit of the collision detecting device according to the invention relative to the frequency of an oscillator when a collision takes place;

FIG. 5 is a graph showing a change in the impedance of a resonant circuit of the collision detecting device according to the invention relative to the frequency of an oscillator when a wire breakdown takes place;

FIG. 6 is a flow diagram of a process for detecting a collision and a wire breakdown;

FIG. 7A is a graph showing an output signal of the resonant circuit when a collision takes place;

FIG. 7B is a graph showing an output signal. of the resonant circuit when a wire breakdown takes place; and

FIG. 8 is a circuit diagram of the collision detecting device according to the second embodiment of the invention.

### DETAILED DESCRIPTION OF THE PREFERRED EMBODIMENTS

Some preferred embodiments according to the present invention will be described with reference to the appended drawings.

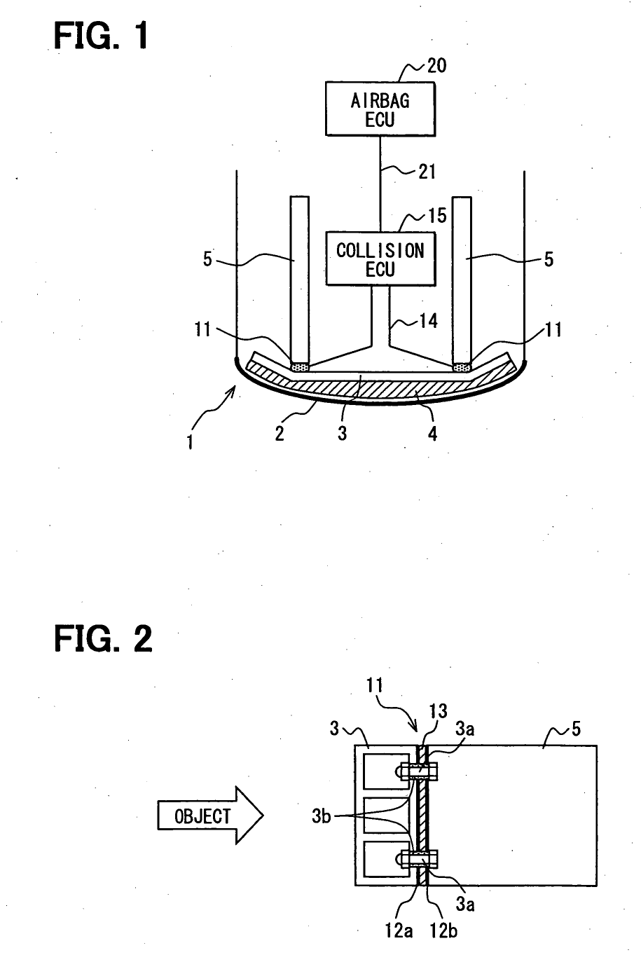

A vehicle collision detecting device according to the first embodiment of the invention will be described with reference to FIGS. 1-7A and 7B.

The vehicle collision detecting device includes a pair of sensors 11 and a collision detecting ECU 15, which is connected by a wire 21 to an airbag ECU 20. The sensors 11 and the collision detecting ECU 15 are connected by lead wires 14. The sensors 11 may be directly connected to the airbag ECU 20 if the collision detecting ECU 15 is included in the airbag ECU 20.

The sensors 11 are mounted in the front bumper 1 of a vehicle. Of course, the sensor 11 may be mounted in a rear bumper or side bumpers. The bumper 1 includes a bumper cover 2, a bumper reinforcement 3, an absorber 4, a pair of side members 5, etc. The bumper cover 2 is made of a resin such as polypropylene and extends laterally from one side of the vehicle to the other to cover the bumper reinforcement 3 and the absorber 4. The bumper reinforcement 3 is a metal beam that extends along the bumper cover 2. The side members 5 are made of a metal and respectively extend longitudinally at opposite sides of the vehicle. The reinforcement 3 is fixed to the front end of the side members 5 by bolts 3a via the sensors 11 and spacers 3b, which are made of an insulating material. The absorber 4 is disposed between the bumper cover 2 and the reinforcement 3 to absorb a shock applied to the front bumper 1.

Each of the sensors 11 is a capacitance type collision sensor that is constituted of a pair of plate electrodes 12a, 12b and a dielectric member 13 disposed between the plate electrodes 12a, 12b. The plate electrodes 12a, 12b are insulated from each other by the spacers 3b. The plate electrode 12a on the side of the bumper reinforcement 3 is connected to the body or ground of the vehicle, and the other electrode 12b is connected by the lead wires 14 to a driving circuit 16 of the collision detecting ECU 15.

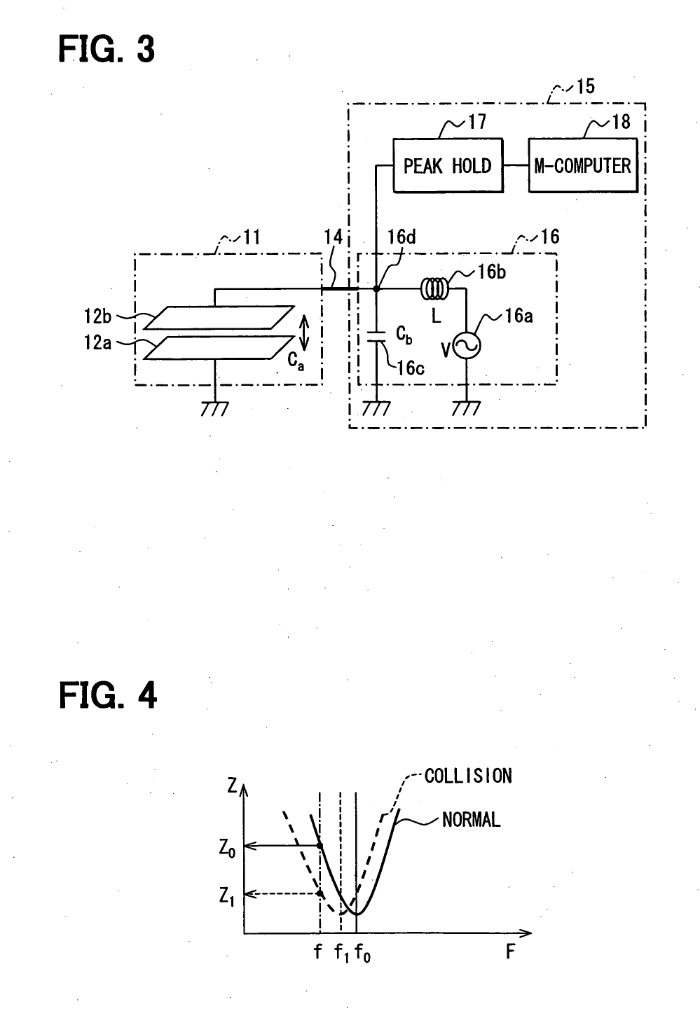

As sown in FIG. 3, the collision detecting ECU 15 is constituted of the driving circuit 16, a peak hold circuit 17 and a microcomputer 18. The driving circuit 16 is constituted of an oscillator 16a, a coil 16b and a diagnostic capacitor 16c. The oscillator 16a generates a sinusoidal ac voltage signal of a fixed frequency f. The diagnostic capacitor 16c and the sensor 11 form a parallel circuit having one end being grounded. The coil 16b is connected in series with the oscillator 16a and the parallel circuit of the sensor 11 and the diagnostic capacitor 16c to form an L-C resonant circuit. Therefore, the normal resonant frequency f₀ of the L-C resonant circuit under the normal condition is expressed as follows: f₀ =1/(2π{square root over (L(Ca+Cb)}), wherein L is the inductance of the coil 16b, Ca is the capacitance of the sensor 11 and Cb is the capacitance of the diagnostic capacitor 16c. The capacitance Cb of the diagnostic capacitor 16c is set to be much smaller than the capacitance Ca of the sensor 11.

The peak hold circuit 17 is connected with a joint 16d of the lead wire 14 that is connected with the driving circuit 16 to hold a peak value of the output voltage of the driving circuit 16 and to send it to the microcomputer 18. The microcomputer 18, which includes an A-D converter, converts the peak voltage of analog value to a digital value and judges whether a collision takes place or not or whether a break down of a lead wire takes place.

If a collision takes place, the sensor 11 is crushed. Accordingly, the distance between the pair of plate electrodes 12a, 12b reduces, thereby increasing the capacitance Ca. As a result, the resonant frequency f₁ becomes lower than the normal resonant frequency f₀, and the impedance of the resonant circuit at the fixed frequency f changes from Z₀ to Z₁ as shown in FIG. 4. Accordingly, the peak voltage at the joint 16d changes from V₀ to V ₁, which is much lower than V₀. The microcomputer 18 compares the peak voltage V₁ with a threshold voltage Vₜₕ₁, and judges that a collision takes place if the peak voltage V₁ is lower than the threshold voltage Vₜₕ₁. Subsequently, the microcomputer 18 sends a collision signal to the airbag ECU 20 via the lead wire 21 so that the airbag ECU 20 can operate a pedestrian protecting air bag based on the collision signal and a vehicle speed, which is detected by a vehicle speed sensor (not shown).

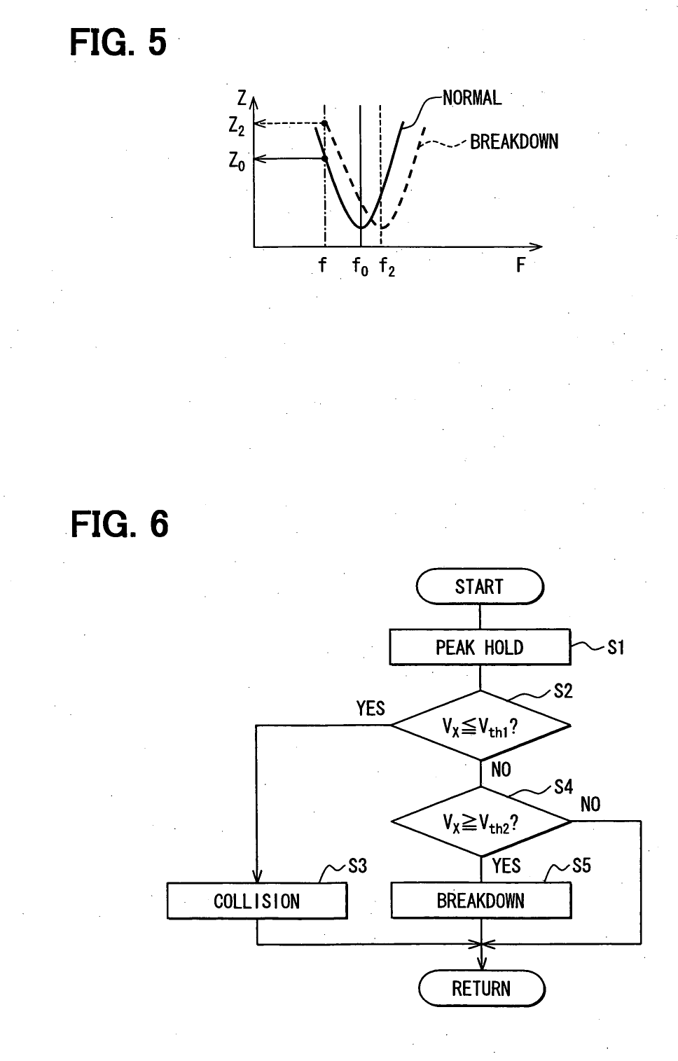

If the lead wire 14 breaks down between the sensor 11 and the driving circuit 16, the capacitance Ca of the L-C resonant circuit drops out. Accordingly, the resonant frequency f₂ becomes higher than the normal resonant frequency f₀, and the impedance of the resonant circuit at the fixed frequency f changes from Z₀ to Z₂ as shown in FIG. 5. Accordingly, the peak voltage at the joint 16d changes from V₀ to V₂, which is much higher than V₀. The microcomputer 18 compares the peak voltage V₂ with a threshold voltage Vₜₕ₂, and judges that a wire breakdown takes place if the peak voltage V₂ is higher than the threshold voltage Vₜₕ₂. As a result, the microcomputer 18 sends a breakdown signal to the airbag ECU 20 via the lead wire 21 so that the airbag ECU 20 can display an alarm of wire breakdown.

The judgment process of the microcomputer 18 is described in more detail with reference to a flow diagram shown in FIG. 6.

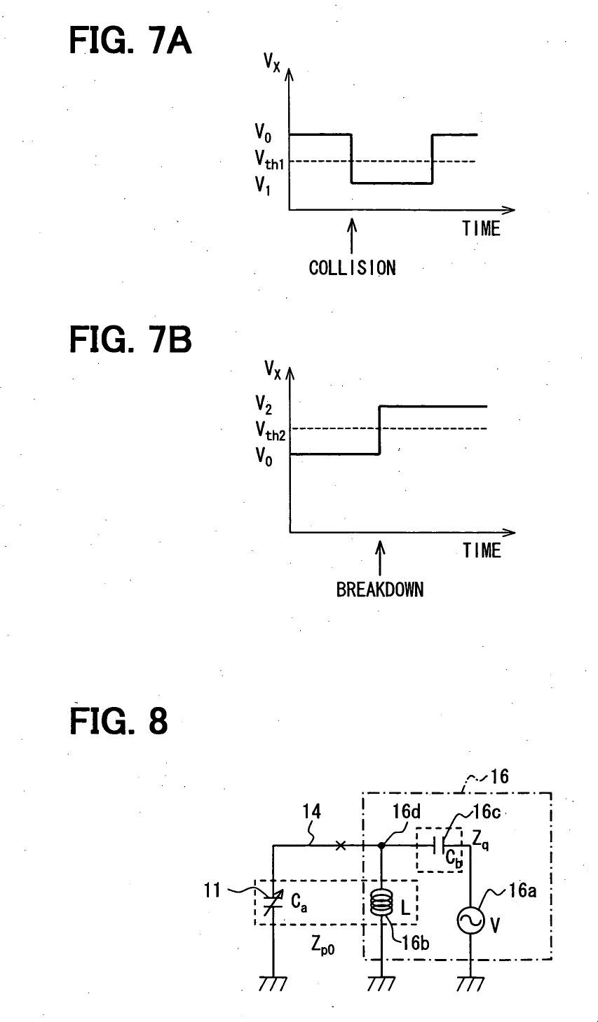

At first step S1, the peak hold circuit 17 takes in a digital peak voltage Vₓ of the joint 16d. Then, whether or not the peak voltage Vₓ is equal to or lower than the first threshold voltage Vₜₕ₁, is examined at S2, as shown in FIG. 7A. If the result of the examination is Yes, a collision signal is sent to the airbag ECU 20 at S3, and the judgment process returns to start again. Incidentally, the first threshold voltage Vₜₕ₁ is set to be lower than the normal peak voltage V₀.

On the other hand, whether or not the peak voltage Vₓ is equal to or higher than the second threshold voltage Vₜₕ₂ is examined at S4, as shown in FIG. 7B, if the result of the examination at S2 is No. If the result of the examination at S4 is Yes, a breakdown signal is sent to the airbag ECU 20 at S5, and the judgment process returns to start again. On the other hand, the judgment process directly returns to start again, if the result of the examination at S4 is No. Incidentally, the second threshold voltage Vₜₕ₂ is set to be higher than the normal peak voltage V₀.

A vehicle collision detecting device according to the second embodiment of the invention will be described with reference to FIG. 8. Incidentally, the same reference numeral shown in FIG. 8 represents the same or substantially the same portion, part or component as the first embodiment.

The driving circuit 16 of the collision detecting device according to the second embodiment includes a coil 16b connected in parallel with the sensor 11 and a diagnostic capacitor 16c connected in series with the sensor 11, the oscillator 16a and the coil 16b.

If a collision takes place, the sensor 11 is crushed to increase the capacitance Ca. Accordingly, the resonant frequency becomes lower than the normal resonant frequency, and the impedance of the resonant circuit lowers. Accordingly, the peak voltage at the joint 16d lowers in the same manner as the first embodiment. If the lead wire 14 breaks down between the sensor 11 and the driving circuit 16, the capacitance Ca of the L-C resonant circuit drops out. Accordingly, the resonant frequency becomes higher than the normal resonant frequency, and the impedance of the resonant circuit increases. Accordingly, the peak voltage at the joint 16d increases in the same manner as the first embodiment.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A vehicle collision detecting device comprising:
a capacitor type sensor mounted on a portion of the vehicle, said sensor having a pair of plate electrodes;
a driving circuit including an oscillator generating an ac signal of a fixed frequency and a resonant circuit constituted of a coil and a diagnostic capacitor, said resonant circuit being connected with said capacitor type sensor so as to compose a portion of the capacitance of said resonant circuit and with said oscillator so as to drive said resonant circuit at the fixed frequency; and
means, connected to said driving circuit at a joint of said sensor and said driving circuit, for judging a collision with an object and a disconnection of said sensor from said driving circuit based on voltage of the joint when the oscillator generates the signal of a fixed frequency.

2. A collision detecting device as in claim 1, wherein said diagnostic capacitor is connected in parallel with said sensor.

3. A collision detecting device as in claim 1, wherein said diagnostic capacitor (16c) is connected in series with said sensor.

4. A collision detecting device as in claim 1, wherein said judging means judges a collision if the voltage at the joint of said sensor and said driving circuit at the fixed frequency is lower than a first threshold voltage.

5. A collision detecting device as in claim 1, wherein said judging means judges a wire breakdown if the voltage at the joint of said sensor and said driving circuit at the fixed frequency is higher than a second threshold voltage.

6. A collision detecting device as in claim 1, wherein:
said judging means includes a peak voltage holding circuit that holds a peak value of the voltage of the lead wire; and
said judging means judges a collision if the peak value of voltage at the joint of said sensor and said driving circuit is lower than a first threshold voltage.

7. A collision detecting device as in claim 1, wherein:
said judging means includes a peak voltage holding circuit that holds a peak value of the voltage of the lead wire; and
said judging means judges a wire breakdown if the peak value of voltage at the joint of said sensor and said driving circuit is higher than a second threshold voltage.

8. A vehicle collision detecting device comprising:
a capacitor type sensor mounted on a portion of the vehicle, said sensor having a pair of plate electrodes and a dielectric member disposed between the electrodes;
a resonant circuit connected to one of the plate electrodes by a lead wire and constituted of a coil and a diagnostic capacitor; and
means for judging a collision with an object and a breakdown of the lead wire according to a change in resonant frequency of said resonant circuit.

9. A vehicle collision detecting device as in claim 8, further comprising an oscillator oscillating said resonant circuit at a fixed frequency, wherein said means judges a collision and a wire breakdown by comparison of the voltage of the lead wire.

10. A vehicle collision detecting device as in claim 9, wherein said means judges a collision with an object if the voltage of the lead wire is lower than a first reference voltage and judges a wire breakdown if the voltage of the lead wire is higher than a second reference voltage.
